(19) United States
(12) Patent Application Publication
(10) Pub. No.: US 2017/0222956 A1
(43) Pub. Date: Aug. 3, 2017

(54) METHOD AND SYSTEM FOR ENABLING AN AUTO RESPONSE FACILITY BETWEEN USERS

(71) Applicants: PRIYA JAIN, LOS ALTOS, CA (US); POOJA BISARYA, SAN DIEGO, CA (US); PRIYA BISARYA, SAN DIEGO, CA (US); LAKSHYA JAIN, LOS ALTOS, CA (US); ROBIN BISARYA, SAN DIEGO, CA (US); DAVE MARVIT, SAN FRANCISCO, CA (US); JEFF UBOIS, CHICAGO, IL (US)

(72) Inventors: PRIYA JAIN, LOS ALTOS, CA (US); POOJA BISARYA, SAN DIEGO, CA (US); PRIYA BISARYA, SAN DIEGO, CA (US); LAKSHYA JAIN, LOS ALTOS, CA (US); ROBIN BISARYA, SAN DIEGO, CA (US); DAVE MARVIT, SAN FRANCISCO, CA (US); JEFF UBOIS, CHICAGO, IL (US)

(21) Appl. No.: 15/011,664

(22) Filed: Feb. 1, 2016

(51) Int. Cl. H04L 12/58

(52) U.S. Cl. CPC H04L 51/02; H04L 51/26; H04L 51/24

(57) ABSTRACT

The present disclosure provides a method and system for enabling an auto-response between one or more users through one or more messages. The computer-implemented method includes a reception of the one or more messages on a communication device. The communication device is associated with a user of the one or more users. Further, the computer-implemented method includes a determination of a level of urgency. The level of urgency is associated with each of the received one or more messages in real time. The computer-implemented method includes a setting of a priority level associated with each of the one or more received messages. Furthermore, the computer-implemented method includes an accumulation of a set of data. The set of data is associated with the user and the communication device. Moreover, the computer-implemented method includes enabling the auto response and an auto notification of one or more relevant measurements.

### TECHNICAL FIELD

The present invention relates to the field of machine learning based messaging and, in particular, relates to a system for enabling an auto-response between one or more users through one or more messages.

### BACKGROUND

In the recent years, the use of messaging applications has dramatically increased. These messaging applications include voice messaging, short text messaging, instant messaging, electronic mail, RSS clients, blogging, micro-blogging and the like. The messaging applications have become a cost efficient way of communicating with individuals having busy schedules. A particular individual receives a lot of messages from clients, co-workers, family members, advertisers, friends and the like. The individual may or may not have time, ability or inclination to read all the urgent messages. Traditionally, answering machines record voicemail messages and play them back in a sequential manner.

Conventionally, the individual listens to each message sequentially to determine if a message is urgent or not. This can be very time consuming for a busy individual. With numerous amounts of messages in the portable devices, finding messages of interest is a tedious task, especially under time constraints. The individual may not be able to reply or read the urgent messages while driving. Therefore, there exists a need for techniques that can effectively categorize the messages based on their urgency and provide an auto-response back to the same message.

In U.S. Pat. No. 8,364,183 B2, a cell phone is provided having software application which responds to the press of one or more busy keys. The software application responds by automatically sending a pre-typed text message to the sender of the latest text message just received or automatically answering an incoming call immediately upon pressing the busy key and playing a pre-recorded audio message. The outgoing text or audio message can inform the sender of the incoming text or the caller that the user is driving or otherwise engaged and cannot respond immediately. In some embodiments, one or more busy keys can be added keys or one or more existing keys on the cell phone or on the keypad of the cell phone or on a touchscreen or a visual depiction of a keypad on a touchscreen of the cell phone.

The conventional methods and prior art are found to be inefficient in categorizing messages based on their urgency and enable auto-response. These prior arts rely completely on a priority set manually by user. In addition, these methods don't take into account a multitude of situations where an urgent message may go unnoticed. These situations include any medical emergency, any business related message, client's message, driving and sleeping. In addition, these prior art rely on conventional vibration pattern and tones to alert the individual about any message. The individual may not be able to distinguish the urgent message from the less important message as both will generate the same vibrational pattern and tone. Moreover, these prior arts are unable to determine the current status of the user and are unable to automatically respond to one or more sender without any interference of the user. Also, the prior art do not allow transmission of response for the urgent messages automatically.

In light of the above stated discussion, there is a need for a method and system which overcomes the above stated disadvantages.

### SUMMARY

In an aspect, the present disclosure provides a computer-implemented method for enabling an auto-response between one or more users through one or more messages. The computer-implemented method includes a reception of the one or more messages on a communication device with a processor. The communication device is associated with the user of the one or more users. Further, the computer-implemented method includes a determination of a level of urgency with the processor. The level of urgency is associated with each of received one or more messages in a real time. Furthermore, the computer-implemented method includes a setting of a priority level with the processor. The priority level is associated with each of the one or more received messages. Further, the computer-implemented method includes an accumulation of a set of data. The set of data is associated with the user. In addition, the set of data is associated with the communication device associated with the user. Moreover, the computer-implemented method includes an enabling of an auto-response and an auto notification of one or more relevant measurements. The auto-response and the auto notification of the one or more relevant measurements are associated with the communication device. The auto-response and the auto notification are enabled based on the urgency level of the one or more messages, the priority level of the one or more messages and the set of data. Further, the one or more messages is received in real time. Furthermore, the level of urgency is determined by analyzing each of the one or more messages. The analysis of each of the one or more received messages is done based on a mining of sentiments associated with subject area of each of the one or more messages and content area of each of the one or more messages. In addition, the analysis of each of the one or more received messages is done based on a user profile associated with the user of the one or more users. The user profile is based on a plurality of parameters. Moreover, the priority level associated with each of the one or more messages is set based on the determined level of urgency. Further, the accumulation of the set of data is performed in the real time. Moreover, the user is a recipient of the one or more messages. In addition, the auto response and the auto notification of relevant measurements is enabled in the real time.

In an embodiment of the present disclosure, the one or more messages are received simultaneously by a cloud server and the communication device associated with the user.

In an embodiment of the present disclosure, the one or more messages includes at least one of one or more text messages, one or more e-mail messages, one or more audio messages, one or more images one or more video messages and one or more multimedia messages.

In an embodiment of the present disclosure, the plurality of parameters includes a past interaction of the user of the one or more users with a corresponding sender and a past interaction of the user with a group of senders. Further, the plurality of parameters includes preference settings of the user of the one or more users, a number of messages associated with each corresponding sender and duration of messaging associated with each of the corresponding sender. In addition, the plurality of parameters includes a time period associated with a conversation with each of the corresponding sender, an identity of sender, a mapping of trigger words and a variation in typing.

In an embodiment of the present disclosure, the priority level is set by ordering, ranking and filtering the one or more messages and the one or more users based on the level of urgency and determining one or more behavioral attributes of one or more users. In addition, the one or more behavioral attributes includes a measure of urgency for the user and a frequency of sending of urgent messages of the one or more messages.

In an embodiment of the present disclosure, the set of data includes a current status of the user. In addition, the set of data includes a current status of the communication device associated with the user. The current status of the user includes one or more physical location of the user in real time, a rate of travel of the user, a physical state of the user and an emotional state of the user. Moreover, the current status of the communication device associated with the user includes battery power of the communication device, communication data, storage data and signal strength of the communication device. In addition, the current status of the communication device associated with the user includes one or more programs in use, one or more applications in use, and an urgency level of other messages awaiting for an attention.

In an embodiment of the present disclosure, the user is a sender of the one or more messages.

In an embodiment of the present disclosure, the auto response and the auto notification of the one or more relevant measurements are medium independent. Moreover, the auto response and the auto notification of the one or more relevant measurements associated with the communication device is enabled through a plurality of techniques. Moreover, the plurality of techniques for enabling the auto response and the auto notification of the one or more relevant measurements includes speech, text, video, clip art, images and one or more encoded messages.

In an embodiment of the present disclosure, the computer-implemented method further includes an update of the plurality of parameters associated with the user and the user profile with the processor.

In an embodiment of the present disclosure, the computer-implemented method further includes a calibration of the user profile with the processor. The calibration of the user profile is based on monitoring a real time variation in the plurality of parameters.

In another aspect, the present disclosure provides a computer program product. The computer program product includes a non-transitory computer readable medium. The non-transitory computer readable programs store a computer readable program. The computer readable program when executed on a computer causes the computer to perform one or more steps. The one or more steps include a reception of the one or more messages on a communication device. The communication device is associated with the user of the one or more users. Further, the one or more steps include a determination of a level of urgency. The level of urgency is associated with each of received one or more messages in a real time. Furthermore, the one or more steps includes a setting of a priority level with the processor. The priority level is associated with each of the one or more received messages. Further, the one or more steps includes an accumulation of a set of data. The set of data is associated with the user. In addition, the set of data is associated with the communication device associated with the user. Moreover, the one or more steps includes an enabling of an auto-response and an auto notification of one or more relevant measurements. The auto-response and the auto notification of the one or more relevant measurements are associated with the communication device. Further, the one or more messages is received in real time. Furthermore, the level of urgency is determined by analyzing each of the one or more messages. The analysis of each of the one or more received messages is done based on a mining of sentiments associated with subject area of each of the one or more messages and content area of each of the one or more messages. In addition, the analysis of each of the one or more received messages is done based on a user profile associated with the user of the one or more users. The user profile is based on a plurality of parameters. Moreover, the priority level associated with each of the one or more messages is set based on the determined level of urgency. Further, the accumulation of the set of data is performed in the real time. Moreover, the user is a recipient of the one or more messages. In addition, the auto response and the auto notification of relevant measurements is enabled in the real time.

In an embodiment of the present disclosure, the computer readable program when executed on the computer causes the computer to update the plurality of parameters associated with the user and the user profile.

In an embodiment of the present disclosure, the computer readable program when executed on the computer causes the computer to calibrate the user profile based on monitoring a real time variation in the plurality of parameters.

In yet another aspect, the present disclosure provides an auto-response system for enabling an auto-response between one or more users through one or more messages. The auto-response system includes a reception module in a processor. The reception module receives the one or more messages on a communication device associated with the user of the one or more users. Further, the auto-response system includes a determination module in the processor. The determination module determines a level of urgency associated with each of the received one or more messages in real time. Furthermore, the auto-response system includes a setting module in the processor. The setting module is configured to set a priority level with the processor. The priority level is associated with each of the one or more received messages. Further, the auto-response system includes an accumulation module in the processor. The accumulation module accumulates a set of data. The set of data is associated with the user. In addition, the set of data is associated with the communication device associated with the user. Moreover, the auto-response system includes an enabling module in the processor. The enabling module enables an auto-response and an auto notification of one or more relevant measurements. The auto-response and the auto notification of the one or more relevant measurements are associated with the communication device. Further, the one or more messages is received in real time. Furthermore, the level of urgency is determined by analyzing each of the one or more messages. The analysis of each of the one or more received messages is done based on a mining of sentiments associated with subject area of each of the one or more messages and content area of each of the one or more messages. In addition, the analysis of each of the one or more received messages is done based on a user profile associated with the user of the one or more users. The user profile is based on a plurality of parameters. Moreover, the priority level associated with each of the one or more messages is set based on the determined level of urgency. Further, the accumulation of the set of data is performed in the real time. Moreover, the user is a recipient of the one or more messages. In addition, the auto response and the auto notification of relevant measurements is enabled in the real time.

In an embodiment of the present disclosure, the one or more messages are received simultaneously by a cloud server and the communication device associated with the user.

In an embodiment of the present disclosure, the set of data includes a current status of the user. In addition, the set of data includes a current status of the communication device associated with the user. The current status of the user includes a physical location of the user in real time. Moreover, the current status of the communication device associated with the user includes battery power of the communication device, communication data, storage data and signal strength of the communication device.

In an embodiment of the present disclosure, the user is a sender of the one or more messages.

In an embodiment of the present disclosure, the auto response and the auto notification of the one or more relevant measurements are medium independent. Moreover, the auto response and the auto notification of the one or more relevant measurements associated with the communication device is enabled through a plurality of techniques. Moreover, the plurality of techniques for enabling the auto response and the auto notification of the one or more relevant measurements includes speech, text, video, clip art, images and one or more encoded messages.

In an embodiment of the present disclosure, the auto-response system further includes an updating module in the processor. The updating module updates the plurality of parameters associated with the user and the user profile.

In an embodiment of the present disclosure, the auto-response system further include a calibration module in the processor. The calibration module calibrates the user profile based on monitoring a real time variation in the plurality of parameters.

### BRIEF DESCRIPTION OF THE FIGURES

Having thus described the invention in general terms, reference will now be made to the accompanying drawings, which are not necessarily drawn to scale, and wherein:

FIG. 1A illustrates an interaction between one or more users for an active messaging session, in accordance with an embodiment of the present disclosure;

FIG. 1B illustrates an interaction between the one or more users for the active messaging session, in accordance with another embodiment of the present disclosure;

FIG. 1C illustrates an interaction between the one or more users and an auto notification server for the active messaging session, in accordance with yet another embodiment of the present disclosure;

FIG. 2 illustrates a block diagram of an auto-response system, in accordance with various embodiment of the present disclosure;

FIG. 3 illustrates a flowchart for providing an auto-response between the one or more users through the one or more messages, in accordance with various embodiments of the present disclosure; and

FIG. 4 illustrates a block diagram of a communication device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

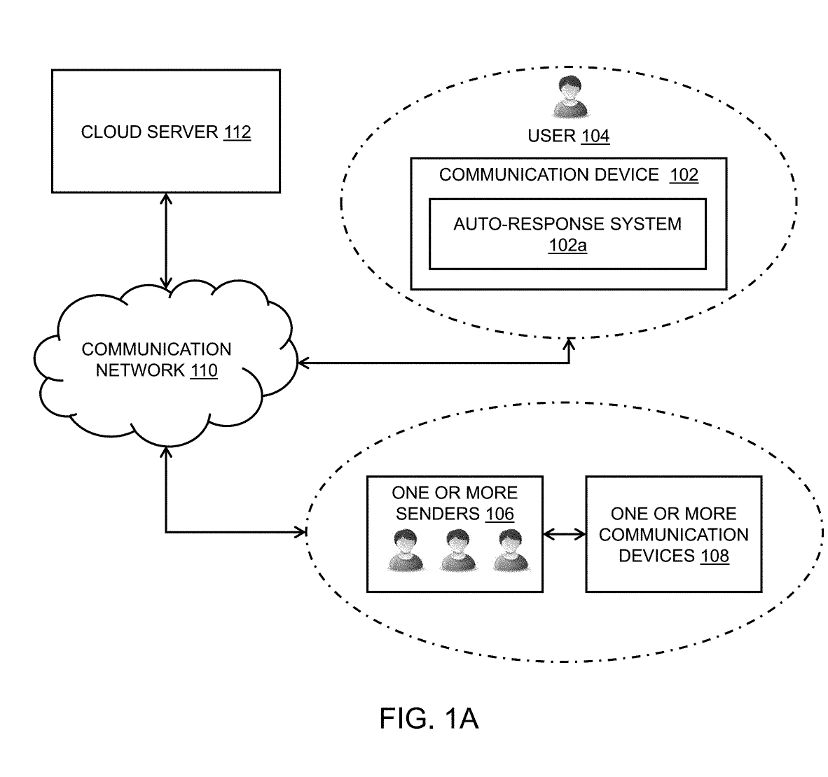

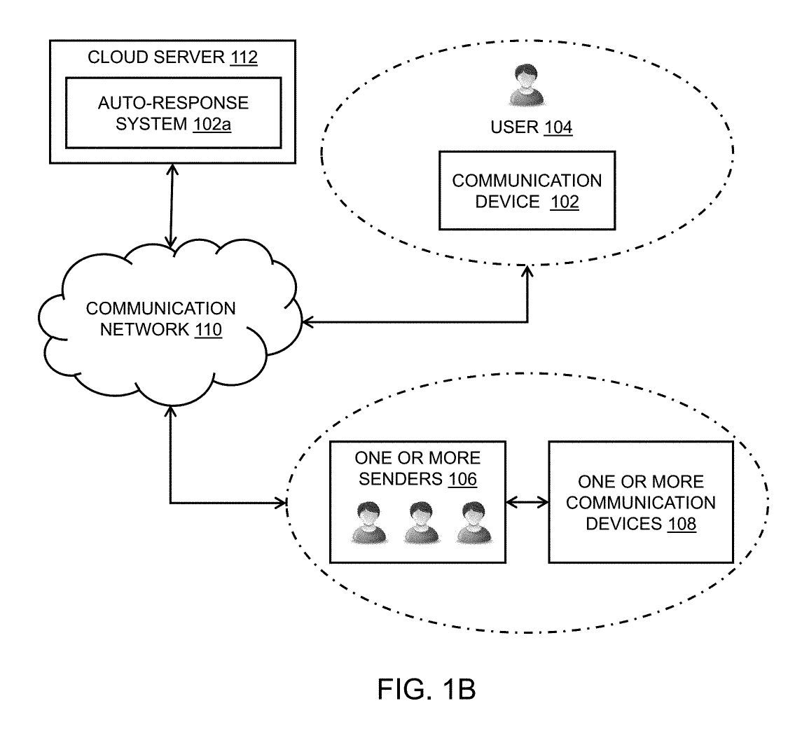

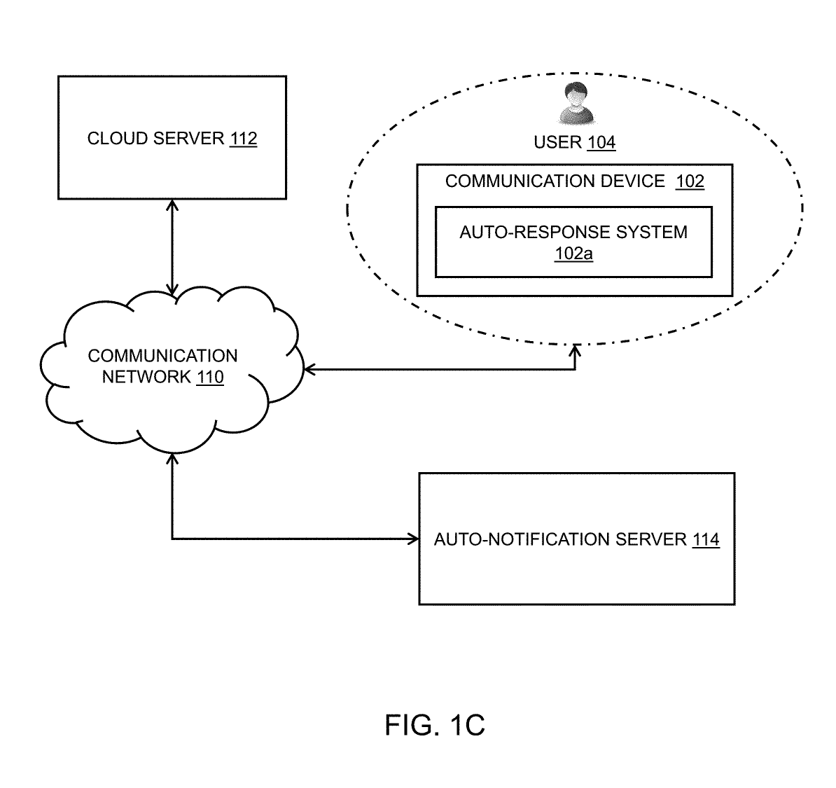

FIG. 1A illustrates an interaction between one or more users for an active messaging session, in accordance with an embodiment of the present disclosure. The interaction between the one or more users is associated with a communication device 102, one or more communication devices 108, a communication network 110 and a cloud server 112. In addition, the communication device 102 is associated with a user 104 and the one or more communication devices 108 are associated with one or more senders 106. The above setup provides hands free messaging between one or more users and enables auto response and auto-notification between the one or more users.

Further, the communication device 102 and the user 104 are present in any place.

The communication device 102 may be any communication device connected to the communication network 110. In an embodiment of the present disclosure, the communication device 102 is a mobile phone. In another embodiment of the present disclosure, the communication device 102 is a tablet. In yet another embodiment of the present disclosure, the communication device 102 is a laptop. In yet another embodiment of the present disclosure, the communication device 102 is a personal digital assistant (hereinafter “PDA”). In addition, the communication device 102 may be any portable or fixed communication device.

In an embodiment of the present disclosure, the communication device 102 is in physical contact with the user 104. In another embodiment of the present disclosure, the communication device 102 is present in a close vicinity of the user 104. Further, the user 104 and the communication device 102 may be present in any suitable place. Examples of the suitable place includes but may not be limited to a highway, a parking lot, a hotel room, an office, a mall, a hospital, a vehicle, an airport and a bathroom. In an embodiment of the present disclosure, the user 104 physically interacts with the communication device 102. In another embodiment of the present disclosure, the user 104 visually interacts with the communication device 102. In yet another embodiment of the present disclosure, the user 104 verbally interacts (speech or audio) with the communication device 102. In yet another embodiment of the present disclosure, the user 104 may interact through any combination of physical, visual and verbal interaction.

The communication device 102 includes a vibration device, one or more audio emitting sources, a multicolor interface screen, a global positioning system (hereinafter “GPS”), a networking device and one or more microphones. Further, the vibration device is an electronic vibrator that vibrates based on instructions from a processor. In addition, the one or more audio emitting sources include inbuilt speakers, Bluetooth speakers and peripheral speakers. The one or more audio emitting sources generate sound based on audio or speech input provided by the communication device 102.

The multicolor interface screen is a display screen designed to display the one or more messages through text, video, images and the like. In an embodiment of the present disclosure, the multicolor interface screen is a capacitive touch screen. In another embodiment of the present disclosure, the multicolor interface screen is a resistive touch screen. In yet another embodiment of the present disclosure, the multicolor interface screen is a touch insensitive screen. In yet another embodiment of the present disclosure, the multicolor interface screen is a gorilla glass. In yet another embodiment of the present disclosure, the multicolor interface screen is a tactile screen.

Further, the GPS in the communication device 102 provides a physical location of the user 104 and an exact time. The physical location of the user 104 includes a latitude and a longitude. The latitude, the longitude and the exact time is used to map an exact physical location of the user 104. Furthermore, the networking device in the communication device 102 may be any device designed to connect to the communication network 110. In an embodiment of the present disclosure, the networking device is based on a global system for mobile communication (hereinafter “GSM”). In another embodiment of the present disclosure, the networking device is based on a code division multiple access (hereinafter “CDMA”). In yet another embodiment of the present disclosure, the networking device is based on a wideband code division multiple access (hereinafter “WCDMA”). In yet another embodiment of the present disclosure, the networking device is based on a long term evolution (hereinafter “LTE”).

Furthermore, the one or more microphones are designed to take speech or sound pattern as input for processing in the communication device 102. Each of the one or more microphones operates synchronously to cancel any surrounding noise. In an embodiment of the present disclosure, the communication device 102 includes an auto-response system 102a. In another embodiment of the present disclosure, the cloud server 112 includes the auto-response system 102a (as shown in FIG. 1B).

Furthermore, the user 104 utilizes the communication device 102 for communicating with other one or more users through the one or more messages. The one or more messages include a short message service (hereinafter “SMS”), a push notification, an electronic mail, a voice mail, a multimedia message (hereinafter “MMS”), a social networking app message and the like. In addition, the communication device 102 receives the one or more messages from the one or more senders 106. In an embodiment of the present disclosure, the communication device 102 receives the one or more messages generated automatically from an auto-notification server 114 (as shown in FIG. 1C). For example, the one or more messages auto-generated from the auto-notification server 114 includes a bank statement, a transaction statement, a ticket booking alert, a travel schedule alert and the like.

Furthermore, the user 104 maintains a contact list accessible to the auto-response system 102a. The contact list includes digital contact identity of the one or more senders 106. The digital contact identity includes a 10 or more digit mobile number. In addition, the digital contact identity includes a name. Moreover, the digital contact identity includes an email address. Further, the digital contact identity includes a virtual contact number. Furthermore, the digital contact identity includes a social media contact. Each of the one or more senders 106 is uniquely identified by the digital contact identity.

Moreover, the communication device 102 runs on an operating system (OS). The OS is installed in a storage space of the communication device 102. In an embodiment of the present disclosure, the OS is an android OS. In another embodiment of the present disclosure, the OS is a BADA OS. In yet another embodiment of the present disclosure, the OS is a Symbian OS. In yet another embodiment of the present disclosure, the OS is an apple iOS. In yet another embodiment of the present disclosure, the OS is a windows OS. In yet another embodiment of the present disclosure, the OS is a blackberry OS. The operating system provides a calling interface, a texting interface, an audio and video playing interface, a physical location tracking interface and the like.

Further, the auto-response system 102a receives the one or more messages on the communication device 102 associated with the user 104 of the one or more users. The one or more messages are received in a real time. In an embodiment of the present disclosure, the auto-response system 102a receives the one or more messages from the one or more communication devices 108. The one or more communication devices 108 are associated with the one or more senders 106. In another embodiment of the present disclosure, the auto-response system 102a receives the one or more messages from the auto-notification server 114 (as shown in FIG. 1C). Moreover, the auto-response system 102a receives the one or more messages from the one or more communication devices 108 through the communication network 110. In an embodiment of the present disclosure, the communication network 110 is an internet based network. In another embodiment of the present disclosure, the communication network 110 is a telecom operator network. In yet another embodiment of the present disclosure, the communication network 110 is a local area network.

Further, the auto-response system 102a determines a level of urgency associated with each of the one or more messages. The auto-response system 102a determines the level of urgency in the real time. The level of urgency is determined from an analysis of each of the one or more messages. The analysis is done based on a mining of sentiments associated with each of the one or more message and a user profile associated with the user 104 of the one or more users. Moreover, the user profile associated with the user 104 is based on a plurality of parameters.

The plurality of parameters includes a past interaction of the user 104 of the one or more users with a corresponding sender of the one or more senders 106. In addition, the plurality of parameters includes a past interaction of the user 104 with a group of senders of one or more senders 106. Moreover, the plurality of parameters includes a preference setting of the user 104 of the one or more users and a number of messages associated with each corresponding sender of the one or more senders 106. In addition, the plurality of parameters includes duration of messaging associated with each of the corresponding sender of the one or more senders 106. Furthermore, the plurality of parameters includes a time period of a conversation with each corresponding sender of the one or more senders 106. Also, the plurality of parameters includes an identity of a sender, a mapping of trigger words and a variation in typing the one or more messages.

Further, the auto-response system 102a mines sentiments from an extraction, sample and comparison of a speech tone, a mapping of keywords in each of the one or more messages with known keywords (related to urgency). The known keywords are present in a database present in the storage space. Further, the auto-response system 102a stores the user profile in the database present in the storage space. Further, the sentiments of the user 104 include but may not be limited to cry, laughter, anger, pain and shock.

Furthermore, the auto-response system 102a sets a priority level associated with each of the one or more received messages. The priority level is set based on the determined level of urgency. The priority level is set by ordering, ranking and filtering the one or more messages and the one or more users based on the level of urgency. In addition, the priority level is set by determining one or more behavioral attributes of the one or more users. The one or more behavioral attributes includes a measure of urgency for the user and a frequency of sending of urgent messages of the one or more messages. The one or more behavioral attributes are presented before the user 104 to manually rank and filter messages and the one or more users. In an embodiment of the present disclosure, the user 104 manually sets a priority list of senders in the preference setting. In another embodiment of the present disclosure, the user sets the priority list of senders in the preference setting based on results from sentiment mining through machine learning based approach. The machine learning based approach is performed through regressive data mining of the sentiments of the user 104.

In an example, the user (U) receives messages from a first sender (V) and a second sender (W). The first sender (V) sends non-urgent messages having urgent keywords frequently and the second sender (W) sends messages actually urgent to the user (U). The auto-response system 102a will mine the level of urgency by sentiment mining of frequency of sent messages having urgent keywords and personal preference set by the user U. In addition, the user U can limit the number of urgent messages from the first sender (V) and prioritize the messages from the second sender (W).

Going further, the auto-response system 102a regularly monitors the variation in varying priority of messages from the one or more users. Further, the auto-response system 102a calibrates the user profile based on monitoring the real time variation in the plurality of parameters. The calibration of the user profile involves an editing of priority and urgency requirements.

Further, the auto-response system 102a accumulates a set of data. The set of data is associated with the user 104 and the communication device 102. The auto-response system 102a accumulates the set of data in the real time. Moreover, the set of data includes a current status of the user 104. The current status of the user 104 includes the physical location of the user 104 in the real time. Furthermore, the set of data includes the current status of the communication device 104. The current status of the communication device 104 includes but may not be limited to battery power, communication data, storage data and signal strength.

The GPS installed in the communication device 102 provides the physical location of the user 104 and the exact time. The physical location of the user 104 includes the latitude and the longitude. The latitude, the longitude and the exact time is used to map the exact physical location of the user 104. In an example, a person (A) is driving a vehicle. The person (A) receives a message from his spouse (B). The message contains a text message “where are you? I am waiting for a dinner”. The person (A) is unable to access the communication device 102 while driving the vehicle. In addition, the person (A) is unable to determine the time duration to reach. The auto-response system 102a accumulates the latitude value and the longitude value associated with the location of the user (A) in the real time. In addition, the auto-response system 102a accumulates the time duration required by the person (A) to reach to the spouse through the GPS.

Going further, the auto-response system 102a enables the auto-response and the auto-notification of one or more relevant measurements. The auto-response and the auto-notification of the one or more relevant measurements are associated with the communication device 102. Moreover, the auto-response system 102a enables the auto-response and the auto-notification of the one or more relevant measurements in the real time. Furthermore, the auto-response system 102a enables the auto response and the auto notification of the one or more relevant measurements based on the urgency level of the one or more messages. In addition, the auto-response system 102a enables the auto response and the auto notification of the one or more relevant measurements based on the priority level of the one or more messages. In addition, the auto-response system 102a enables the auto response and the auto notification of the one or more relevant measurements based on the set of data accumulated.

Furthermore, the auto-response system 102a enables the auto response and the auto notification of the one or more relevant measurements through a plurality of techniques. The plurality of techniques includes speech, text, clip art and images. In an example, a user (say, X) is driving a car. The user (X) receives a message from his colleague any meeting in an office. The user (X) cannot access his communication device 102. The auto-response system 102a determines the level of urgency of the received message. The auto-response system 102a enables the auto-response associated with the physical location of the user (X). In addition, the auto-response system 102a sends the auto-response associated with the physical location to the colleague. Moreover, the auto-response system 102a automatically enable a call to the colleague as soon as the user (X) reaches the office.

In another example, a user (say, Y) is driving a car. The user (Y) receives a message from his colleague during a meeting in an office. The user (Y) cannot access his communication device 102. The auto-response system 102a determines the level of urgency of the received message. The auto-response system 102a enables one or more auto-responses to the user (Y). Moreover, the auto-response system 102a suggests the one or more auto-responses to the user (Y). The auto-response system 102a suggest the one or more auto-responses through the speech to the user (Y). The user (Y) selects a preferred response from the one or more auto-response suggested. In addition, the auto-response system 102a converts the preferred response into text and sends one or more messages to the colleague.

In yet another example, a person (F) and a person (G) are in conversation with each other. A communication device (H) is associated with the person (F). A communication device (I) is associated with the person (G). The person (F) utilizes the communication device (H) for conversation. In addition, the person (G) utilizes the communication device (I) for conversation. Suddenly, battery power percentage of the communication device (H) is low (say 3%). The auto-response system 102a automatically sends the auto-response to the person (G) regarding low battery power of the communication device (H).

In yet another example, a person (J) and a person (K) are in conversation with each other. A communication device (L) is associated with the person (J). A communication device (M) is associated with the person (K). The person (J) utilizes the communication device (L) for conversation. In addition, the person (K) utilizes the communication device (M) for conversation. Suddenly, battery power percentage of the communication device (L) is low (say 2%). The auto-response system 102a enables an auto-notification to the person (J) regarding the low battery power of the communication device (H). In addition, the auto-response system 102a suggests the person (J) to send a final message to the person (K).

In yet another example, a person (J) and a person (K) are in conversation with each other. A communication device (L) is associated with the person (J). A communication device (M) is associated with the person (K). The person (J) utilizes the communication device (L) for conversation. In addition, the person (K) utilizes the communication device (M) for conversation. Suddenly the communication data of the communication device (L) is low (say 100 kb). The auto-response system 102a automatically sends the auto-response to the person (K) regarding a low communication data of the communication device (L).

It may be noted that in FIG. 1A, FIG. 1B and FIG. 1C, the user 104 is associated with the communication device 102; however, those skilled in the art would appreciate that the user 104 is associated with more number of communication devices. Moreover, it may be noted that in FIG. 1A and FIG. 1B, the communication device 102 is connected to the one or more senders 106 through the communication network 110; however, those skilled in the art would appreciate that the communication device 102 is connected to more number of communication networks 110 simultaneously.

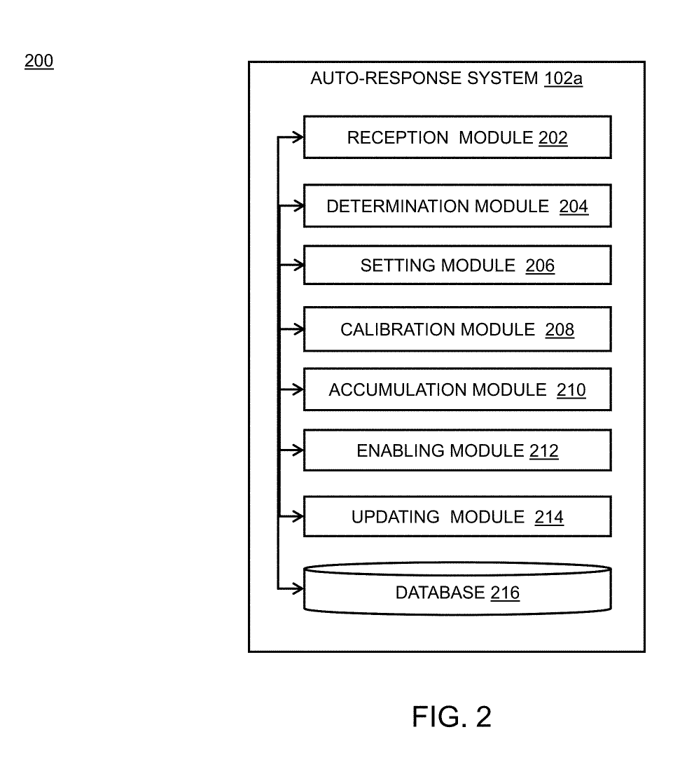

FIG. 2 illustrates a block diagram 200 of the auto-response system 102a, in accordance with various embodiments of the present disclosure. It may be noted that to explain the system elements of the FIG. 2, references will be made to the system elements of the FIG. 1A, FIG. 1B and FIG. 1C. The auto-response system 102a provides an automatic hands free active messaging session between the one or more users. In addition, the auto-response system 102a enables the user 104 to provide the auto-response to messages of the one or more messages with a higher level of urgency in real time (as stated above in the detailed description of the FIG. 1A, FIG. 1B and FIG. 1C).

The block diagram 200 illustrates a plurality of components of the auto-response system 102a. The plurality of components of the auto-response system 102a include a reception module 202, a determination module 204, a setting module 206, a calibration module 208, an accumulation module 210, an enabling module 212, an updating module 214 and a database 216. The above stated components of the auto-response system 102a enable the auto-response between the one or more users.

The auto-response system 102a is associated with the communication device 102 of the user 104 (as discussed above in the detailed description of the FIG. 1A). In an embodiment of the present disclosure, the auto-response system 102a is associated with the cloud server 112 (as mentioned above in the detailed description of the FIG. 1B). The cloud server 112 controls each and every operation performed by the auto-response system 102a. In an embodiment of the present disclosure, the auto-response system 102a is associated with a software application installed on the communication device 102. The software application runs in the background of the communication device 102.

Further, the software application enables the user 104 to optimize the preference settings. The preference settings allow the user 104 to store a list of people who have a higher priority level than other users in case of any emergency. In an embodiment of the present disclosure, the user 104 sets the preferences related to the messages of which users are important than others (as stated above in the detailed description of the FIG. 1A, FIG. 1B and FIG. 1C). In an embodiment of the present disclosure, the one or more senders 106 send the one or more messages through the corresponding one or more communication devices 108 in the real time. In another embodiment of the present disclosure, the auto-notification server 114 sends the one or more messages in the real time.

Going further, the reception module 202 of the auto-response system 102a receives the one or more messages on the communication device 102 associated with the user 104 of the one or more users. The one or more messages are received through the communication network 110 (as stated above in the detailed description of the FIG. 1A). Moreover, the one or more messages are sent by the one or more senders 106 through the corresponding one or more communication devices 108. Also, the one or more messages are sent by the auto-notification server 114.

In an embodiment of the present disclosure, the reception module 202 receives a single message from a sender of the one or more senders 106. In another embodiment of the present disclosure, the reception module 202 receives more than one message from the sender of the one or more senders 106. In yet another embodiment of the present disclosure, the reception module 202 receives a plurality of messages from a corresponding plurality of senders in real time. Moreover, the one or more messages are received on any messaging software application installed on the communication device 102.

Further, the determination module 204 of the auto-response system 102a determines the level of urgency associated with each of the received one or more messages in the real time. Furthermore, the determination module 204 determines the level of urgency from the analysis of each of one or more received messages. The analysis of each of the one or more received messages is done based on the mining of sentiments associated with each of the one or more messages. In addition, the analysis of each of the one or more received messages is done based on the user profile associated with the user 104 of the one or more users (as discussed above in the detailed description of the FIG. 1A, FIG. 1B and FIG. 1C).

The user profile is based on the plurality of parameters. The plurality of parameters include the past interaction of the user 104 of the one or more users with the corresponding sender and the past interaction of the user 104 with the group of senders. Further, the plurality of parameters includes the preference settings of the user 104 of the one or more users and the number of messages associated with each corresponding sender. Furthermore, the plurality of parameters includes the duration of messaging associated with each of the corresponding sender. In addition, the plurality of parameters includes the time period associated with the conversation with each of the corresponding sender, the identity of the sender, the mapping of the trigger words and the variation in typing (as mentioned above in the detailed description of the FIG. 1A, FIG. 1B and FIG. 1C).

Further, the setting module 206 of the auto-response system 102a sets the priority level associated with each of the one or more received messages. The priority level is set based on the determined level of urgency. The setting module 206 sets the priority by ordering, ranking and filtering the one or more messages and the one or more users based on the level of urgency. In addition, the setting module 206 sets the priority level by determining the one or more behavioral attributes of the one or more users (as discussed above in the detailed description of FIG. 1A, FIG. 1B and FIG. 1C). In addition, the calibration module 208 of the auto-response system 102a calibrates the user profile associated with the user 104. The calibration of the user profile involves the editing of priority and urgency requirements. The calibrating module 208 calibrates the user profile based on monitoring the real time variation in the plurality of parameters.

Further, the accumulation module 210 of the auto-response system 102a accumulates the set of data. The set of data is associated with the user 104 and the communication device 102. The accumulation module 210 accumulates the set of data in the real time. Moreover, the set of data includes the current status of the user 104. The current status of the user 104 includes the physical location of the user 104 in the real time. Furthermore, the set of data includes the current status of the communication device 104. The current status of the communication device 104 includes but may not be limited to the battery power, the communication data, the storage data and the signal strength (as discussed in the detailed description of FIG. 1A, FIG. 1B and FIG. 1C).

Going further, the enabling module 212 of the auto-response system 102a enables the auto-response and the auto-notification of one or more relevant measurements. The auto-response and the auto-notification of the one or more relevant measurements are associated with the communication device 102. Moreover, the enabling module 212 enables the auto-response and the auto-notification of the one or more relevant measurements in the real time. In an embodiment of the present disclosure, the one or more relevant measurements corresponding to the current status of the communication device 104. Furthermore, the enabling module 212 enables the auto response and the auto notification of the one or more relevant measurements based on the urgency level of the one or more messages. In addition, the enabling module 212 enables the auto response and the auto notification of the one or more relevant measurements based on the priority level of the one or more messages. In addition, the enabling module 212 enables the auto response and the auto notification of the one or more relevant measurements based on the set of data accumulated (as described in the detailed description of FIG. 1A, FIG. 1B and FIG. 1C).

Further, the updating module 214 of the auto-response system 102a updates the plurality of parameters associated with the user 104 and the user profile. The update is done in real time (as mentioned above in the detailed description of the FIG. 1A, FIG. 1B and FIG. 1C). Furthermore, the database 216 of the auto-response system 102a stores the user profile associated with the user 104, the plurality of parameters, the received one or more messages, the determined level of urgency and the auto-response.

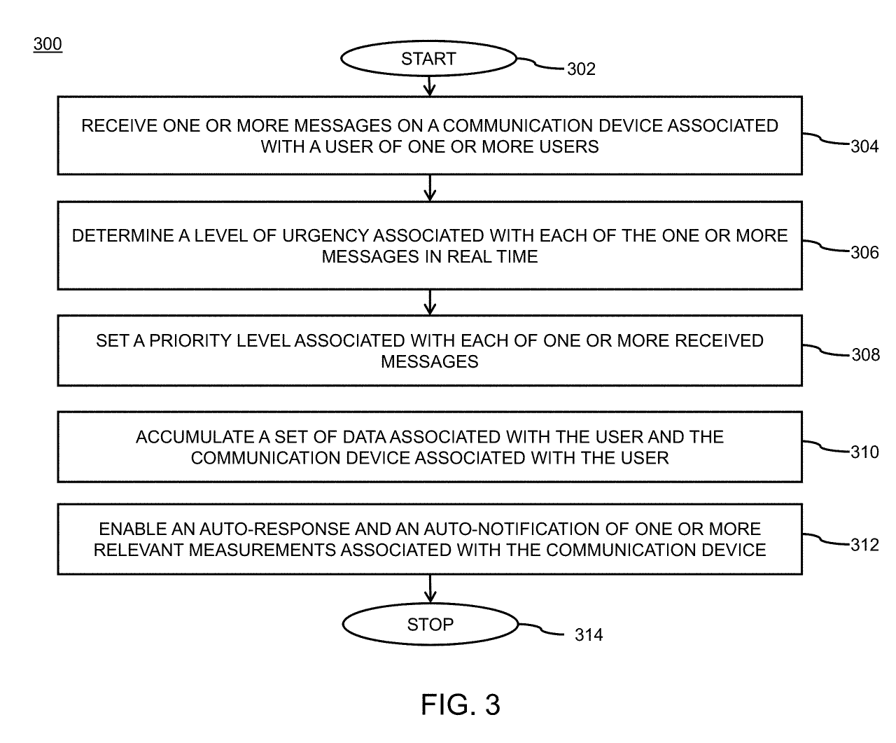

FIG. 3 illustrates a flowchart 300 for providing the auto-response between the one or more users through the one or more messages, in accordance with various embodiments of the present disclosure. It may be noted that to explain the process steps of the flowchart 300, references will be made to the auto-response system elements of the FIG. 1A, FIG. 1B, FIG. 1C and FIG. 2.

The flowchart 300 initiates at step 302. At step 304, the reception module 202 receives the one or more messages on the communication device 102. The communication device 102 is associated with the user 104 of the one or more users. Further, at step 306, the determination module 204 determines the level of urgency associated with each of the one or more messages in the real time. The level of urgency is associated with each of the received one or more messages in the real time. Furthermore, the level of urgency is determined from the analysis of each of the one or more received messages. The analysis of each of the one or more received messages is done based on the mining of sentiments associated with each of the one or more messages. Moreover, at step 308, the setting module 206 sets the priority level associated with each of the one or more received messages. The priority level is set based on the determined level of urgency. Furthermore, at step 310, the accumulation module 210 accumulates the set of data. The set of data is associated with the user 104 and the communication device 102 associated with the user 104. Moreover, at step 312, the enabling module 212 enables the auto response and the auto notification of the one or more relevant measurements. The auto-response and the auto-notification of the one or more relevant measurements are associated with the communication device 102. The flow chart 300 terminates at step 314.

It may be noted that the flowchart 300 is explained to have above stated process steps; however, those skilled in the art would appreciate that the flowchart 300 may have more/less number of process steps which may enable all the above stated embodiments of the present disclosure.

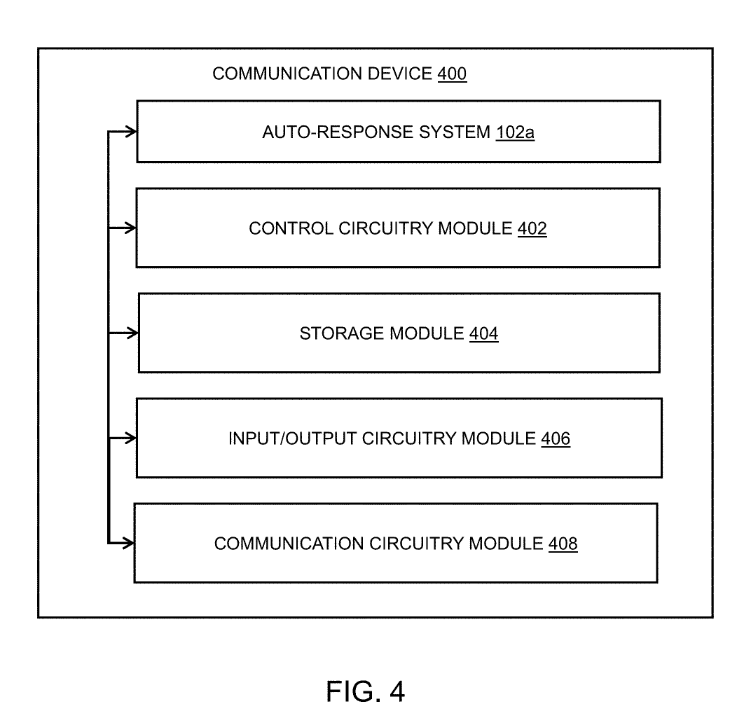

FIG. 4 illustrates a block diagram of a communication device 400, in accordance with various embodiments of the present disclosure. The communication device 400 enables host process of the auto-response system 102a. The communication device 400 includes a control circuitry module 402, a storage module 404, an input/output circuitry module 406, and a communication circuitry module 408. The communication device 400 includes any suitable type of portable electronic device. The communication device 400 includes but may not be limited to a personal e-mail device (e.g., a Blackberry™ made available by Research in Motion of Waterloo, Ontario), a personal data assistant (“PDA”), a cellular telephone. In addition, the communication device 400 includes a smartphone, the laptop, computer and the tablet. In another embodiment of the present disclosure, the communication device 400 can be a desktop computer.

From the perspective of this disclosure, the control circuitry module 402 includes any processing circuitry or processor operative to control the operations and performance of the communication device 400. For example, the control circuitry module 402 may be used to run operating system applications, firmware applications, media playback applications, media editing applications, or any other application.

In an embodiment of the present disclosure, the control circuitry module 402 drives a display and process inputs received from the user interface. From the perspective of this disclosure, the storage module 404 includes one or more storage mediums. The one or more storage medium includes a hard-drive, solid state drive, flash memory, permanent memory such as ROM, any other suitable type of storage component, or any combination thereof. The storage module 404 may store, for example, media data (e.g., music and video files), application data (e.g., for implementing functions on the communication device 400).

From the perspective of this disclosure, the I/O circuitry module 406 may be operative to convert (and encode/decode, if necessary) analog signals and other signals into digital data. In an embodiment of the present disclosure, the I/O circuitry module 406 may convert the digital data into any other type of signal and vice-versa. For example, the I/O circuitry module 406 may receive and convert physical contact inputs (e.g., from a multi-touch screen), physical movements (e.g., from a mouse or sensor), analog audio signals (e.g., from a microphone), or any other input. The digital data may be provided to and received from the control circuitry module 402, the storage module 404, or any other component of the communication device 400.

It may be noted that the I/O circuitry module 406 is illustrated in FIG. 4 as a single component of the communication device 400; however those skilled in the art would appreciate that several instances of the I/O circuitry module 406 may be included in the communication device 400.

The communication device 400 may include any suitable interface or component for allowing the user to provide inputs to the I/O circuitry module 406. The communication device 400 may include any suitable input mechanism. Examples of the input mechanism include but may not be limited to a button, keypad, dial, a click wheel, and a touch screen. In an embodiment, the communication device 400 may include a capacitive sensing mechanism, or a multi-touch capacitive sensing mechanism.

In an embodiment of the present disclosure, the communication device 400 may include specialized output circuitry associated with output devices such as, for example, one or more audio outputs. The audio output may include one or more speakers built into the communication device 400, or an audio component that may be remotely coupled to the communication device 400.

The one or more speakers can be mono speakers, stereo speakers, or a combination of both. The audio component can be a headset, headphones or ear buds that may be coupled to the communication device 400 with a wire or wirelessly.

In an embodiment, the I/O circuitry module 406 may include display circuitry for providing a display visible to a user. For example, the display circuitry may include a screen (e.g., an LCD screen) that is incorporated in the communication device 400.

The display circuitry may include a movable display or a projecting system for providing a display of content on a surface remote from the communication device 400 (e.g., a video projector). In an embodiment of the present disclosure, the display circuitry may include a coder/decoder to convert digital media data into the analog signals. For example, the display circuitry may include video Codecs, audio Codecs, or any other suitable type of Codec.

The display circuitry may include display driver circuitry, circuitry for driving display drivers or both. The display circuitry may be operative to display content. The display content can include media playback information, application screens for applications implemented on the electronic device, information regarding ongoing communications operations, information regarding incoming communications requests, or device operation screens under the direction of the control circuitry module 402. Alternatively, the display circuitry may be operative to provide instructions to a remote display.

In addition, the communication device 400 includes the communication circuitry module 408. The communication circuitry module 408 may include any suitable communication circuitry operative to connect to a communication network. In addition, the communication circuitry module 408 may include any suitable communication circuitry to transmit communications (e.g., voice or data) from the communication device 400 to other devices. The other devices exist within the communications network. The communications circuitry 408 may be operative to interface with the communication network through any suitable communication protocol. Examples of the communication protocol include but may not be limited to Wi-Fi, Bluetooth®, radio frequency systems, infrared, LTE, GSM, GSM plus EDGE, CDMA, and quadband.

In an embodiment, the communications circuitry module 408 may be operative to create a communications network using any suitable communications protocol. For example, the communication circuitry module 408 may create a short-range communication network using a short-range communications protocol to connect to other devices. For example, the communication circuitry module 408 may be operative to create a local communication network using the Bluetooth,® protocol to couple the communication device 400 with a Bluetooth,® headset.

It may be noted that the computing device is shown to have only one communication operation; however, those skilled in the art would appreciate that the communication device 400 may include one more instances of the communication circuitry module 408 for simultaneously performing several communication operations using different communication networks. For example, the communication device 400 may include a first instance of the communication circuitry module 408 for communicating over a cellular network, and a second instance of the communication circuitry module 408 for communicating over Wi-Fi or using Bluetooth®.

In an embodiment of the present disclosure, the same instance of the communications circuitry module 408 may be operative to provide for communications over several communication networks. In another embodiment of the present disclosure, the communication device 400 may be coupled to a host device for data transfers and sync of the communication device 400. In addition, the communication device 400 may be coupled to software or firmware updates to provide performance information to a remote source (e.g., to providing riding characteristics to a remote server) or performing any other suitable operation that may require the communication device 400 to be coupled to the host device. Several computing devices may be coupled to a single host device using the host device as a server. Alternatively or additionally, the communication device 400 may be coupled to the several host devices (e.g., for each of the plurality of the host devices to serve as a backup for data stored in the communication device 400).

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A computer-implemented method for enabling an auto-response between one or more users through one or more messages, the computer-implemented method comprising:
receiving, with a processor, the one or more messages on a communication device associated with a user of the one or more users, wherein the one or more messages being received in real time;
determining, with the processor, a level of urgency associated with each of the one or more messages in real time, wherein the level of urgency being determined by analyzing each of the one or more messages, wherein the analyzing being done based on mining of sentiments associated with a subject area of each of the one or more messages, a content area of each of the one or more messages and a user profile associated with the user of the one or more users and wherein the user profile being based on a plurality of parameters;
setting, with the processor, a priority level associated with each of the one or more received messages, wherein the priority level being set based on the determined level of urgency;
accumulating, with the processor, a set of data associated with the user and the communication device associated with the user, wherein the user is a recipient of the one or more messages and wherein the accumulation of the set of data being performed in real time; and
enabling, with the processor, an auto response and an auto notification of one or more relevant measurements associated with the communication device based on the urgency level of the one or more messages, the priority level of the one or more messages and the set of data, wherein the auto response and the auto notification of the one or more relevant measurements being enabled in the real time.

2. The computer-implemented method as recited in claim 1, wherein the one or more messages being received simultaneously by a cloud server and the communication device associated with the user.

3. The computer-implemented method as recited in claim 1, wherein the one or more messages comprises at least one of one or more text messages, one or more e-mail messages, one or more audio messages, one or more images, one or more video messages and one or more multimedia messages.

4. The computer-implemented method as recited in claim 1, wherein the plurality of parameters comprises a past interaction of the user of the one or more users with a corresponding sender, a past interaction of the user with a group of senders, a preference settings of the user of the one or more users, number of messages associated with each corresponding sender, duration of messaging associated with each of the corresponding sender, a time period associated with a conversation with each of the corresponding sender, an identity of each of the corresponding sender, a mapping of trigger words and a variation in typing.

5. The computer-implemented method as recited in claim 1, wherein the priority level being set by ordering, ranking and filtering the one or more messages and the one or more users based on the level of urgency and determining one or more behavioral attributes of the one or more users and wherein the one or more behavioral attributes comprises a measure of urgency for the user and a frequency of sending of urgent messages of the one or more messages.

6. The computer-implemented method as recited in claim 1, wherein the set of data comprises a current status of the user and a current status of the communication device associated with the user, wherein the current status of the user comprises one or more physical location of the user in real time, a rate of travel of the user, a physical state of the user and an emotional state of the user, and wherein the current status of the communication device associated with the user comprises battery power of the communication device, communication data, storage data, signal strength of the communication device, one or more programs in use, one or more applications in use, and an urgency level of other messages awaiting for an attention.

7. The computer-implemented method as recited in claim 1, wherein the user being a sender of the one or more messages.

8. The computer-implemented method as recited in claim 1, wherein, the auto response and the auto notification of the one or more relevant measurements being medium independent, wherein the auto response and the auto notification of the one or more relevant measurements associated with the communication device being enabled through a plurality of techniques, wherein the plurality of techniques comprises speech, text, video, clip art, images and one or more encoded messages.

9. The computer-implemented method as recited in claim 1, further comprising updating, with the processor, the plurality of parameters associated with the user and the user profile.

10. The computer-implemented method as recited in claim 1, further comprising calibrating, with the processor, the user profile based on monitoring a real time variation in the plurality of parameters.

11. A computer program product comprising a non-transitory computer readable medium storing a computer readable program, wherein the computer readable program when executed on a computer causes the computer to perform steps comprising:
receiving one or more messages on a communication device associated with a user of one or more users, wherein the one or more messages being received in real time;
determining a level of urgency associated with each of the one or more messages in real time, wherein the level of urgency being determined by analyzing each of the one or more messages, wherein the analyzing being done based on mining of sentiments associated with a subject area of each of the one or more messages, a content area of each of the one or more messages and a user profile associated with the user of the one or more users and wherein the user profile being based on a plurality of parameters;
setting a priority level associated with each of the one or more received messages, wherein the priority level being set based on the determined level of urgency;
accumulating a set of data associated with the user and the communication device associated with the user, wherein the user being a recipient of the one or more messages and wherein the accumulation of the set of data being performed in real time; and
enabling an auto response and an auto notification of one or more relevant measurements associated with the communication device based on the urgency level of the one or more messages, the priority level of the one or more messages and the set of data, wherein the auto response and the auto notification of the one or more relevant measurements being enabled in the real time.

12. The computer program product as recited in claim 11, wherein the computer readable program when executed on the computer causes the computer to perform a further step of updating the plurality of parameters associated with the user and the user profile.

13. The computer program product as recited in claim 11, wherein the computer readable program when executed on the computer causes the computer to perform a further step of calibrating the user profile based on monitoring a real time variation in the plurality of parameters.

14. A system for enabling an auto-response between one or more users through one or more messages, the comprising:
a reception module in a processor, the reception module being configured to receive one or more messages on a communication device associated with a user of one or more users, wherein the one or more messages being received in real time;
a determination module in the processor, the determination module being configured to determine a level of urgency associated with each of the one or more messages in real time, wherein the level of urgency being determined by analyzing each of the one or more messages, wherein the analyzing being done based on mining of sentiments associated with a subject area of each of the one or more messages, a content area of each of the one or more messages and a user profile associated with the user of the one or more users and wherein the user profile being based on a plurality of parameters;
a setting module in the processor, the setting module being configured to set a priority level associated with each of the one or more received messages, wherein the priority level being set based on the determined level of urgency;
an accumulation module in the processor, the accumulation module being configured to accumulate a set of data associated with the user and the communication device associated with the user, wherein the user being a recipient of the one or more messages and wherein the accumulation of the set of data being performed in real time; and
an enabling module in the processor, the enabling module being configured to enable an auto response and an auto notification of one or more relevant measurements associated with the communication device based on the urgency level of the one or more messages, the priority level of the one or more messages and the set of data, wherein the auto response and the auto notification of the one or more relevant measurements being enabled in the real time.

15. The auto-response system as recited in claim 14, wherein the one or more messages being received simultaneously by a cloud server and the communication device associated with the user.

16. The auto-response system as recited in claim 14, wherein the set of data comprises a current status of the user and a current status of the communication device associated with the user, wherein the current status of the user comprises one or more physical location of the user in real time, a rate of travel of the user, a physical state of the user and an emotional state of the user, and wherein the current status of the communication device associated with the user comprises battery power of the communication device, communication data, storage data, signal strength of the communication device, one or more programs in use, one or more applications in use, and an urgency level of other messages awaiting for an attention.

17. The auto-response system as recited in claim 14, wherein the user being a sender of the one or more messages.

18. The auto-response system as recited in claim 14, wherein the auto response and the auto notification of the one or more relevant measurements being medium independent, wherein the auto response and the auto notification of the one or more relevant measurements associated with the communication device being enabled through a plurality of techniques and wherein the plurality of techniques comprises speech, text, video, clip art, images and one or more encoded messages.

19. The auto-response system as recited in claim 14, further comprising an updating module in the processor, the updating module being configured to update the plurality of parameters associated with the user and the user profile.

20. The auto-response system as recited in claim 14, further comprising a calibration module in the processor, the calibration module being configured to calibrate the user profile based on monitoring a real time variation in the plurality of parameters.
